(19) United States
(12) Patent Application Publication
(10) Pub. No.: US 2025/0142688 A1
(43) Pub. Date: May 1, 2025

(54) COOKING DEVICES, METHODS, AND COMPONENTS THEREOF

(71) Applicant: SharkNinja Operating LLC, Needham, MA (US)

(72) Inventors: Sean Dorsey, Needham, MA (US); Edward Brown, Needham, MA (US); Ethan Brown, Needham, MA (US); Gianluca Mazzi, Needham, MA (US); Zachary Veugen, Needham, MA (US); Adam Garland, Needham, MA (US); Amanda Ng, Needham, MA (US)

(21) Appl. No.: 19/006,813

(22) Filed: Dec. 31, 2024

Related U.S. Application Data
(63) Continuation of application No. PCT/US2024/036903, filed on Jul. 5, 2024.
(60) Provisional application No. 63/512,523, filed on Jul. 7, 2023.

(51) Int. Cl. H05B 6/64; A47J 37/06; F24C 15/32

(52) U.S. Cl. CPC H05B 6/6473; A47J 37/0641; A47J 37/0664; F24C 15/325; H05B 6/6408

(57) ABSTRACT

A device including a housing having a front surface and an opening positioned on the front surface; a door rotatably connected to the housing to selectively cover the opening; a cooking chamber formed within the housing, the cooking chamber comprising an inner top wall, wherein the cooking chamber is configured to be accessed through the opening; a microwave source positioned outside of the cooking chamber, and configured to emit microwaves into the cooking chamber; an air movement device positioned within the housing; a heating element positioned within the housing; and a container selectively removable from the cooking chamber, the cooking chamber comprising a top opening for inserting a food product therein, wherein, in a first cooking mode, the container is spaced from the inner top wall, and in a second cooking mode, the container is positioned directly adjacent the inner top wall.

### CROSS-REFERENCE TO RELATED APPLICATIONS

The present application is a continuation of International Application No. PCT/US2024/036903, filed on Jul. 5, 2024, and entitled “COOKING DEVICES, METHODS, AND COMPONENTS THEREOF,” which claims priority to U.S. Provisional Patent Application No. 63/512,523 entitled “COOKING DEVICES, METHODS, AND COMPONENTS THEREOF” filed on Jul. 7, 2023, which is hereby incorporated by reference in its entirety.

### FIELD

A countertop cooking system including a one or more convection and radiant heating elements in combination with a microwave heating element, and methods for using the same, are provided.

### BACKGROUND

Traditional microwave cooking systems typically include a microwave source (i.e., a magnetron) that directs microwave energy at food disposed in a cooking compartment therein. The microwave energy heats water molecules in the food, turning the water molecules into steam. Since a traditional microwave only includes a microwave source, the air in the microwave is relatively cool, which allows the steam to condense once microwaves are no longer absorbed by the food. This rapid condensing for steam means that moisture is left on the surface of the food, which leads to an undesirable reheating or cooking result, since there is no means of evaporation to remove the moisture created during the microwaving process.

### SUMMARY

In some aspects, the techniques described herein relate to a device, including: a housing having a cooking chamber formed therein, the cooking chamber including an inner top wall; a microwave source positioned outside of the cooking chamber, and configured to emit microwaves into the cooking chamber; an air movement device positioned within the housing, and can be vertically above the inner top wall; a heating element positioned within the housing, and can be vertically above the inner top wall; and a container selectively removable from the cooking chamber, the cooking chamber including a top opening for inserting a food product therein, wherein, in a first cooking mode, the container is spaced from the inner top wall, and in a second cooking mode, the container is positioned directly adjacent the inner top wall.

In some aspects, the techniques described herein relate to a device, wherein the cooking chamber container includes a bracket positioned on at least one of a sidewall or the inner top wall.

In some aspects, the techniques described herein relate to a device, wherein the container includes a projection extending outward from the container and is configured to abut the bracket in the second cooking mode.

In some aspects, the techniques described herein relate to a device, wherein the inner top wall includes at least one aperture.

In some aspects, the techniques described herein relate to a device, wherein in the first cooking mode, the microwave source emits microwaves into the cooking chamber.

In some aspects, the techniques described herein relate to a device, wherein in the second cooking mode, the air movement device and heating element generate a heated airflow directly into the container.

In some aspects, the techniques described herein relate to a device, wherein the container partially seals to the inner top wall to reduce a rate of loss of the heated airflow from the container to the cooking chamber.

In some aspects, the techniques described herein relate to a device, wherein the cooking chamber includes a shelf positioned within the cooking chamber and spaced vertically from a bottom surface of the cooking chamber.

In some aspects, the techniques described herein relate to a device, wherein the container abuts the shelf in the second cooking mode to position the container directly adjacent the inner top wall.

In some aspects, the techniques described herein relate to a device, wherein the microwave source is positioned within a second chamber arranged adjacent to the cooking chamber.

In some aspects, the techniques described herein relate to a device, including: a housing forming a cooking chamber therein, the cooking chamber including an inner top wall; a microwave source positioned outside of the cooking chamber, and configured to emit microwaves into the cooking chamber; an air movement device positioned within the housing, and configured to generate an airflow within the cooking chamber; a heating element positioned within the housing, and configured to heat the airflow to create a heated airflow; a bracket positioned within the cooking chamber; and a container selectively removable from the cooking chamber, the cooking chamber including a top opening for inserting a food product therein, and a projection extending outward from the container, wherein the projection of the container contacts the bracket to position the container directly adjacent the inner top wall.

In some aspects, the techniques described herein relate to a device, wherein the bracket surrounds the container on a first side, a second side, and a third side of the container.

In some aspects, the techniques described herein relate to a device, wherein the bracket is positioned on at least one of the inner top wall or a sidewall of the cooking chamber.

In some aspects, the techniques described herein relate to a device, wherein the inner top wall includes a plurality of perforations to allow the heated airflow to pass through the inner top wall and into the cooking chamber.

In some aspects, the techniques described herein relate to a device, wherein, in a first cooking mode, the container is spaced from the inner top wall and the microwave source emits microwaves into the cooking chamber.

In some aspects, the techniques described herein relate to a device, wherein, in a second cooking mode, the container is positioned directly adjacent the inner top wall and the air movement device and heating element direct the heated airflow directly into the container.

In some aspects, the techniques described herein relate to a device, wherein the bracket is spaced horizontally from a sidewall of the cooking chamber.

In some aspects, the techniques described herein relate to a device, wherein the container partially seals to the inner top wall to reduce a rate of loss of the heated airflow from the container to the cooking chamber.

In some aspects, the techniques described herein relate to a device, wherein the cooking chamber includes a shelf positioned within the cooking chamber and spaced vertically from a bottom surface of the cooking chamber.

In some aspects, the techniques described herein relate to a device, wherein the container abuts the shelf in the second cooking mode to position the container directly adjacent the inner top wall.

In some aspects, the techniques described herein relate to a device, including: a housing having a front surface and an opening positioned on the front surface; a door rotatably connected to the housing to selectively cover the opening; a cooking chamber formed within the housing having a first volume, wherein the cooking chamber is configured to be accessed through the opening and to cook a food product directly therein; a microwave source positioned outside of the cooking chamber, and configured to emit microwaves into the cooking chamber; an air movement device positioned within the housing; a heating element positioned within the housing; and a container having a second volume and selectively removable from the cooking chamber, the container including a top opening for inserting the food product therein, wherein the first volume is larger than the second volume.

In some aspects, the techniques described herein relate to a device, wherein the first volume is within a range of 0.7 cubic feet to 0.9 cubic feet.

In some aspects, the techniques described herein relate to a device, wherein the first volume is 0.8 cubic feet.

In some aspects, the techniques described herein relate to a device, wherein the second volume is within a range of 0.10 cubic feet to 0.15 cubic feet.

In some aspects, the techniques described herein relate to a device, wherein the second volume is 0.13 cubic feet.

In some aspects, the techniques described herein relate to a device, wherein the first volume is within a range of 1.0 cubic feet to 1.2 cubic feet.

In some aspects, the techniques described herein relate to a device, wherein the first volume is 1.1 cubic feet.

In some aspects, the techniques described herein relate to a device, wherein the second volume is within a range of 0.18 cubic feet to 0.22 cubic feet.

In some aspects, the techniques described herein relate to a device, wherein the second volume is 0.20 cubic feet.

In some aspects, the techniques described herein relate to a device, wherein a ratio of the first volume to the second volume is within a range of 5.3:1 to 6.3:1.

In some aspects, the techniques described herein relate to a device, wherein a ratio of the first volume to the second volume is 5.50:1.

In some aspects, the techniques described herein relate to a device, wherein a ratio of the first volume to the second volume is 6.15:1.

In some aspects, the techniques described herein relate to a device, wherein in a first cooking mode, microwave source emits microwaves into the cooking chamber.

In some aspects, the techniques described herein relate to a device. wherein in a second cooking mode, the air movement device and heating element direct a heated airflow directly into the container.

In some aspects, the techniques described herein relate to a device, including: a housing forming a cooking chamber therein having a first height and a first width, the cooking chamber including an inner top wall; a microwave source positioned outside of the cooking chamber, and configured to emit microwaves into the cooking chamber to cook a food product directly therein; an air movement device positioned within the housing, and configured to generate an airflow within the cooking chamber; a heating element positioned within the housing, and configured to heat the airflow to create a heated airflow; and a container having a second height and a second width, and being selectively removable from the cooking chamber, the container including a top opening for inserting the food product therein, wherein the first height is at least double the second height.

In some aspects, the techniques described herein relate to a device, wherein the cooking chamber includes a first volume within a range of 0.7 cubic feet to 1.2 cubic feet.

In some aspects, the techniques described herein relate to a device, wherein the container includes a second volume within a range of 0.10 cubic feet to 0.22 cubic feet.

In some aspects, the techniques described herein relate to a device, wherein a ratio of the first volume to the second volume is within a range of 5.3:1 to 6.3:1.

In some aspects, the techniques described herein relate to a device, wherein the cooking chamber includes a shelf positioned within the cooking chamber and spaced vertically from a bottom surface of the cooking chamber.

In some aspects, the techniques described herein relate to a device, wherein the container is configured to be positioned on the shelf, and a second container is configured to be positioned below the shelf within the cooking chamber.

In some aspects, the techniques described herein relate to a device, including: a housing having a cooking chamber formed therein, the cooking chamber including an inner top wall and a sidewall; a microwave source positioned outside of the cooking chamber, and configured to emit microwaves into the cooking chamber; a mode stirrer positioned on the sidewall of the cooking chamber; an air movement device positioned within the housing; a heating element positioned within the housing; and a container selectively removable from the cooking chamber, the container including a top opening for inserting a food product therein, wherein, in a first cooking mode, the microwave source emits microwaves into the cooking chamber and the mode stirrer rotates to distribute the microwaves emitted into the cooking chamber, and in a second cooking mode, the air movement device and heating element direct a heated airflow directly into the container.

In some aspects, the techniques described herein relate to a device, wherein housing includes a second chamber arranged adjacent to the cooking chamber in a side-by-side configuration.

In some aspects, the techniques described herein relate to a device, wherein the microwave source is positioned within the second chamber.

In some aspects, the techniques described herein relate to a device, wherein a wave guide is positioned within the second chamber and configured to direct microwaves from the microwave source to the cooking chamber.

In some aspects, the techniques described herein relate to a device, wherein the mode stirrer is positioned at an outlet of the wave guide.

In some aspects, the techniques described herein relate to a device, wherein the mode stirrer is connected to a driveshaft of a motor passing through the wave guide in order to rotate the mode stirrer.

In some aspects, the techniques described herein relate to a device, wherein the sidewall of the cooking chamber separates the cooking chamber from the second chamber.

In some aspects, the techniques described herein relate to a device, wherein the mode stirrer includes a first aperture and a second aperture.

In some aspects, the techniques described herein relate to a device, wherein at least one of the first aperture and the second aperture is a rectangular aperture.

In some aspects, the techniques described herein relate to a device, wherein the mode stirrer is asymmetric.

In some aspects, the techniques described herein relate to a device, including: a housing forming a cooking chamber therein, the cooking chamber including a top wall, a rear wall, and a sidewall; a microwave source positioned outside of the cooking chamber, and configured to emit microwaves into the cooking chamber; a mode stirrer positioned on the sidewall of the cooking chamber; an air movement device positioned within the housing, and configured to generate an airflow within the cooking chamber; a heating element positioned within the housing, and configured to heat the airflow to create a heated airflow; and a container selectively removable from the cooking chamber, the container including a top opening for inserting a food product therein.

In some aspects, the techniques described herein relate to a device, wherein housing includes a second chamber arranged adjacent to the cooking chamber in a side-by-side configuration.

In some aspects, the techniques described herein relate to a device, wherein the sidewall of the cooking chamber separates the cooking chamber from the second chamber.

In some aspects, the techniques described herein relate to a device, wherein the microwave source is positioned within the second chamber.

In some aspects, the techniques described herein relate to a device, wherein a wave guide is positioned within the second chamber and configured to direct microwaves from the microwave source to the cooking chamber.

In some aspects, the techniques described herein relate to a device, wherein a motor is positioned within the second chamber and configured to rotate the mode stirrer.

In some aspects, the techniques described herein relate to a device, wherein the mode stirrer includes a projection extending axially outward towards the cooking chamber.

In some aspects, the techniques described herein relate to a device, wherein the projection is adjacent an aperture positioned within the mode stirrer.

In some aspects, the techniques described herein relate to a device, wherein a mica sheet is positioned between the mode stirrer and the cooking chamber.

In some aspects, the techniques described herein relate to a device, wherein the mode stirrer is asymmetric.

In some aspects, the techniques described herein relate to a device, including: a housing having a cooking chamber formed within the housing, the cooking chamber including an inner top wall; a microwave source positioned outside of the cooking chamber, and configured to emit microwaves into the cooking chamber; a motor positioned outside of the cooking chamber, and including a first pulley connected to a driveshaft of the motor; an air movement device positioned within the housing, the air movement device including a driveshaft extending vertically upward and having a second pulley; a belt extending between the first pulley and the second pulley, the belt configured to transfer rotational movement from the first pulley to the second pulley; a heating element positioned within the housing; and a container selectively removable from the cooking chamber, the container including a top opening for inserting a food product therein.

In some aspects, the techniques described herein relate to a device, wherein housing includes a second chamber arranged adjacent to the cooking chamber in a side-by-side configuration.

In some aspects, the techniques described herein relate to a device, wherein the microwave source and the motor are positioned within the second chamber.

In some aspects, the techniques described herein relate to a device, wherein the motor is positioned above the microwave source.

In some aspects, the techniques described herein relate to a device, wherein the motor includes a cooling fan configured to rotate within the second chamber.

In some aspects, the techniques described herein relate to a device, wherein the motor and the air movement device are horizontally spaced and vertically aligned from one another within the housing.

In some aspects, the techniques described herein relate to a device, wherein in a first cooking mode, the motor rotates the first pulley in order to rotate the air movement device to produce an airflow.

In some aspects, the techniques described herein relate to a device, wherein the second pulley is positioned vertically above the heating element.

In some aspects, the techniques described herein relate to a device, wherein the first pulley includes a plurality of teeth circumferentially arranged about the first pulley.

In some aspects, the techniques described herein relate to a device, wherein the belt includes a plurality of teeth corresponding to the plurality of teeth of the first pulley.

In some aspects, the techniques described herein relate to a device, including: a housing forming a cooking chamber and a second chamber therein, the cooking chamber including an inner top wall and a sidewall separating the cooking chamber and the second chamber; a microwave source positioned within the second chamber, and configured to emit microwaves into the cooking chamber to cook a food product directly therein; a motor positioned within the second chamber, and including a first pulley connected to a driveshaft of the motor, the first pulley positioned vertically above the cooking chamber; an air movement device positioned within the housing, and can be vertically above the inner top wall, the air movement device including a driveshaft extending vertically upward and having a second pulley vertically aligned within the first pulley; a belt extending between the first pulley and the second pulley, the belt configured to transfer rotational movement from the first pulley to the second pulley; a heating element positioned within the housing, and can be vertically above the inner top wall; and a container selectively removable from the cooking chamber, the container including a top opening for inserting a food product therein.

In some aspects, the techniques described herein relate to a device, wherein the cooking chamber and the second chamber are arranged within the housing in a side-by-side configuration.

In some aspects, the techniques described herein relate to a device, wherein the motor is positioned above the microwave source.

In some aspects, the techniques described herein relate to a device, wherein the motor includes a cooling fan configured to rotate within the second chamber.

In some aspects, the techniques described herein relate to a device, wherein the motor and the air movement device are horizontally spaced from one another within the housing.

In some aspects, the techniques described herein relate to a device, wherein in a first cooking mode, the motor rotates the first pulley in order to rotate the air movement device to produce an airflow.

In some aspects, the techniques described herein relate to a device, wherein in a second cooking mode, the microwave source emits microwaves into the cooking chamber.

In some aspects, the techniques described herein relate to a device, wherein the second pulley is positioned vertically above the heating element.

In some aspects, the techniques described herein relate to a device, wherein the first pulley includes a plurality of teeth circumferentially arranged about the first pulley.

In some aspects, the techniques described herein relate to a device, wherein the belt includes a plurality of teeth corresponding to the plurality of teeth of the first pulley.

Accordingly, there is a need for cooking systems that include the speed and efficiency of a microwave, while also creating an adequate Maillard reaction on a food product.

### DESCRIPTION OF DRAWINGS

These and other features will be more readily understood from the following detailed description taken in conjunction with the accompanying drawings, in which:

FIG. 1 is a perspective view of an embodiment of a cooking system according to the subject matter described herein;

FIG. 2 is a cross-sectional view of the cooking system taken along line 2-2 in FIG. 1;

FIG. 3A is a top cross-sectional view of the cooking system taken along line 3A-3A of FIG. 1;

FIG. 3B is a top perspective view of the cooking system of FIG. 1 with an outer shell removed;

FIG. 4 is an isolated perspective view of a belt drive system of the cooing system of FIG. 1;

FIG. 5A is a cross-sectional view of the cooking system taken along line 5A-5A in FIG. 1;

FIG. 5B is a cross-sectional view of the cooking system of FIG. 5A without a container in a cooking volume;

FIG. 5C is a detailed view of the container of FIG. 5A;

FIG. 5D is a detailed view of the container of FIG. 5C;

FIG. 6A is a cross-sectional view of the cooking system taken along line 6A-6A in FIG. 1;

FIG. 6B is a cross-sectional view of the cooking system taken along line 6B-6B in FIG. 1;

FIG. 7A is an isolated perspective view of a mode stirrer and internal cover of the cooking system of FIG. 1; and

FIG. 7B is an isolated perspective view of the reflective cover of the cooking system of FIG. 7A.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Traditional countertop cooking systems such as air fryers typically consist of a heating element and a fan positioned overtop of a cooking cavity. These types of cooking devices can take a relative long amount of time to cook or reheat food due to the slow nature of convective heat exchange. Microwaves can be used to cook or reheat food relatively quickly due to the absorption of microwaves by the food, causing a generation of steam within the food. However, microwaves can leave food soggy and moist due to the condensed steam remaining on and in the food after a cooking process. Although the basic function of a microwave oven is to heat food by dielectric heating (i.e., via directly acting microwaves absorbed in the food), this disclosure includes microwave ovens that include additional kinds of cooking capabilities, such as a crisp (or browning) function or a grill function, thereby enabling preparation of various types of food items and providing new culinary effects. Such additional kinds of cooking capabilities usually require additional components such as a browning plate or a grill element.

Embodiments of the cooking systems and methods described herein advantageously provide a system that can reheat and/or cook quickly using microwaves, while also providing a crisping and browning feature to remove generated water vapor from food due to the microwaving process to create a more desirable finished food product.

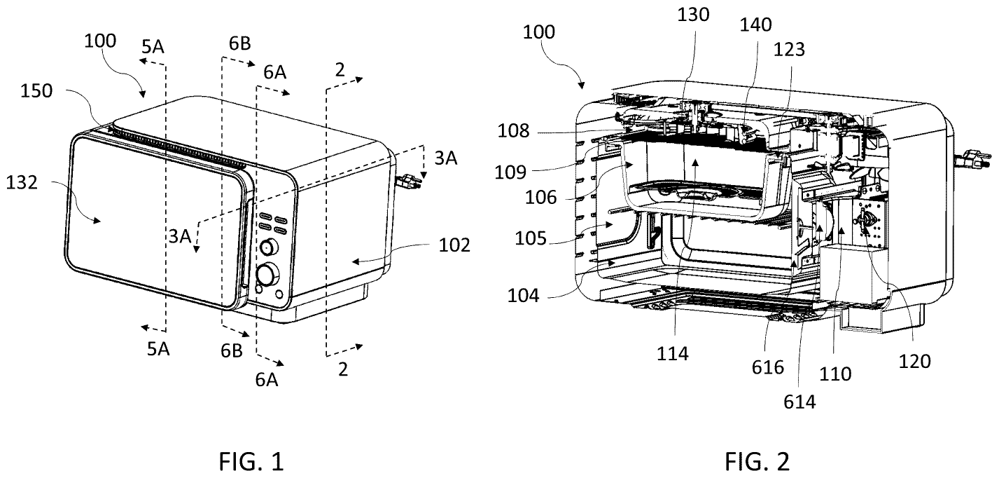

FIGS. 1-4 depict an embodiment of a cooking system 100 according to the subject matter described herein. In some embodiments, the cooking system 100 can include a housing 102 that comprises a cooking volume 104, an inner container 106, an upper volume 108, and a side volume 110. A door 132 can be movably and rotatably arranged on the housing 102 in order to selectively close the cooking volume 104.

In an aspect, the cooking volume 104 is a main cooking chamber where a food product is inserted for a cooking process. Cooking volume 104 is formed from an inner shell 105 within the housing 102, and can act as shielding for microwaves and heat, which will be described in greater detail below. An air gap can be positioned around the inner shell 105 and the housing 102 to insulate the cooking volume 104 from the housing 102 regarding heat transfer.

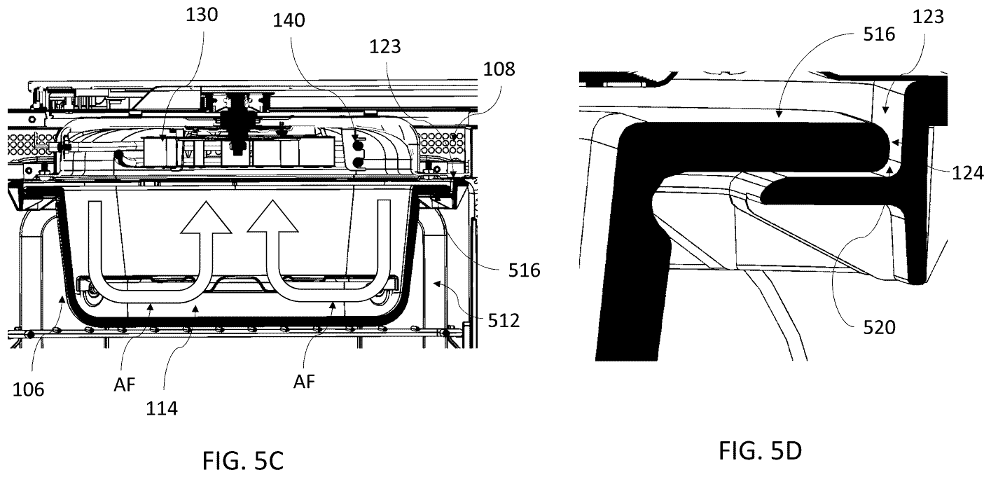

FIGS. 5A-5C illustrate a cross-sectional view of the cooking system 100 with a more detailed view of the cooking volume 104 and the components therein. As shown, the cooking volume 104 can include a tray 502 configured to separate the cooking volume 104 into an upper cooking volume 512 and lower cooking volume 514. In an aspect, a user of the cooking system may desire to place two food items in the cooking volume 104 and therefore, can separate each item by use of the tray 502. Upper cooking volume 512 can provide for either a food item or the container 106. For instance, FIG. 5B illustrates the cooking volume 104 with the container 106 removed and exposing the upper cooking volume 512. When the container is removed, the fan 130 can provide circulated air throughout the entire cooking volume 104. In an aspect, the circulated air that can reach both the food placed on the tray 502 and the upper cooking volume 512, along with the food placed in the lower cooking volume 514 can be evenly cooked when the air circulated from the fan 130 is on.

Defining the top surface of the cooking volume 104 is an inner top wall 109. The inner top wall 109 separates the upper volume 108 from the cooking volume 104. The upper volume 108 is arranged within the housing 102 and positioned vertically above the cooking volume 104. The inner top wall 109 includes a plurality of apertures arranged therein, and is configured to allow an airflow to pass from the upper volume 108 into the cooking volume 104, as described in greater detail below. The inner top wall 109 can also protect components within the upper volume 108 from food splatter, which can be generated during a cooking process. The inner top wall 109 can be made from a metallic material, and can also include a single aperture, or a plurality of apertures 111 arranged in a specific pattern to aid in airflow from the upper volume 108 to the cooking volume 104. The pattern in which the apertures 111 are arranged can correspond to the dimensions of the opening of the inner container 106, as described in greater detail below.

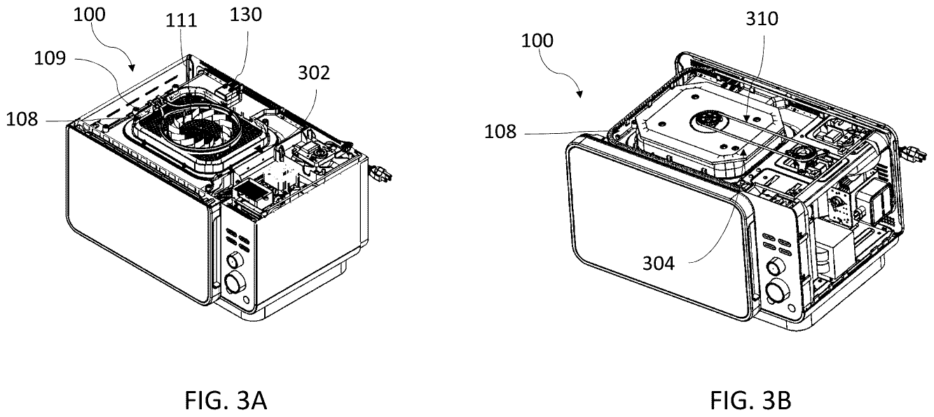

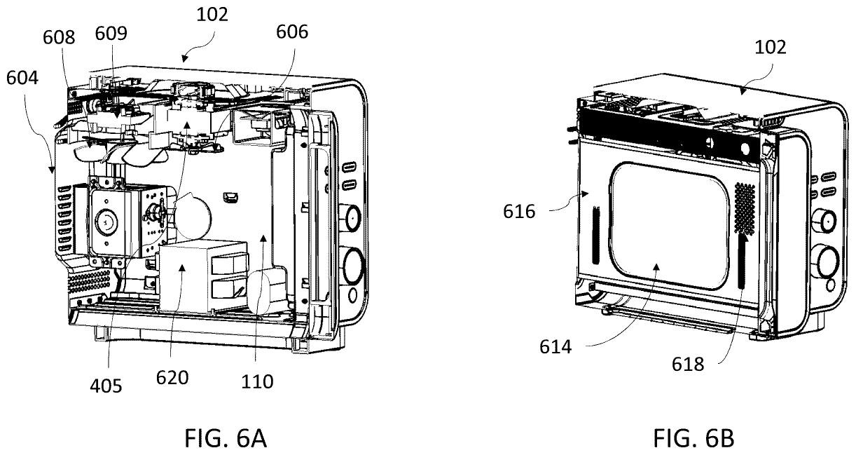

FIGS. 2 and 6A-7 depict a perspective view of the side volume 110 of the cooking system 100. The side volume 110 is separated from the cooking volume 114 via the sidewall 616. As shown in FIG. 6A, the side volume 110 can include a magnetron 620 positioned adjacent a rear wall 604 of the side volume 110. The magnetron 620 is configured to emit electromagnetic waves as a microwave source to the cooking volume 104. In order to direct the microwaves from the magnetron 620 to the cooking volume 104, a wave guide 617 is positioned within the side volume 110. The wave guide 617 is a metallic conduit that contains and directs microwaves form the magnetron 620 to the cooking volume 104. In an aspect, the wave guide 617 is positioned on the sidewall 616, with an inlet at the magnetron 620, and an outlet at an aperture in the sidewall 616.

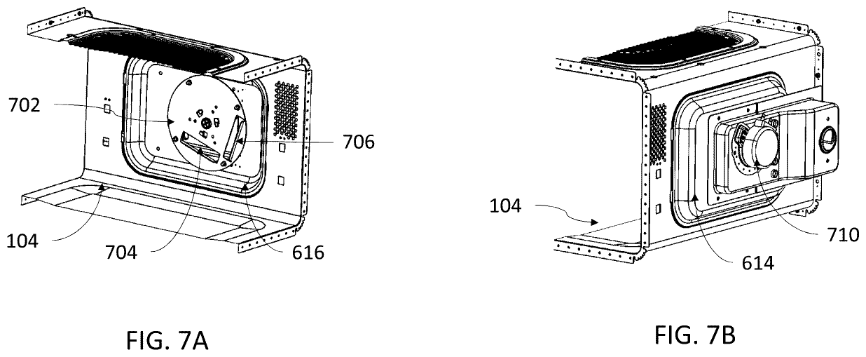

A mode stirrer 702 is positioned adjacent the aperture in the sidewall 616, as shown in FIG. 7A. The mode stirrer 702 is configured to randomly distribute the microwaves from the microwave assembly 120 within the cooking volume 104 in order to ensure even heating during a cooking process using microwaves. As described in greater detail below, the mode stirrer 702 can rotate around a central axis in order to enhance the distribution of the microwave energy throughout the cooking volume 104.

The mode stirrer 702 can be circular in shape, and also can be flat in a single plane, or include bent projections which extend axially from the plane of rotation. In an aspect, the mode stirrer can include a first slot 704 and second slot 706, wherein the first slot 704 and second slot 706 are configured to randomly scatter the microwaves from the magnetron 620 throughout the cooking volume 104. The slots 704, 706 can be rectangular in shape, and include a projection extending axially into the cooking volume 104 from an edge of the slots 704, 706.

As shown in FIG. 7B, the mode stirrer 702 is coupled to an electric motor 710 positioned in the side volume 110 and through the waveguide 614. A driveshaft extends through the waveguide 614 and non-rotatably connects to the mode stirrer 702 in order to translate rotational movement from the motor 710 to the mode stirrer 702. In an aspect, the mode stirrer 702 can rotate continuously during a cooking mode where the microwave assembly 120 is in operation and emitting microwaves into the cooking volume 104. In an aspect, the mode stirrer 702 can rotate at a single speed during a cooking operation. Additionally, in an aspect, the mode stirrer 702 can vary its rotational speed depending on a cooking process. As shown in FIG. 6B, the mode stirrer is positioned on the sidewall 616 behind a mica sheet 614. The mica sheet 614 allows microwaves to pass through and into the cooking volume 104, while keeping the mode stirrer 702 hidden from the view of a user.

When in operation for a cooking process, heat is generated within the side volume 110 due to the magnetron 620 and the motor 405 being arranged therein. To help discharge excessive heat within the side volume 110, the side volume 110 can include a fan 608 powered by a motor 609, which is positioned on a top wall 606. Additionally, the motor 405 includes a fan 606. Further shown in FIG. 6B, the side volume 110 can comprise a sidewall 616 configured with venting holes 618.

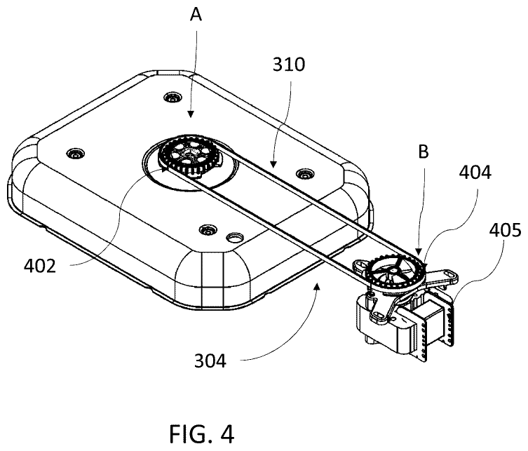

Arranged in the upper volume 108 is an air movement device 130 (i.e., a fan). The air movement device 130 is configured to generate an airflow into the cooking volume 104 during a convection heating process. In an aspect, the air movement device 130 can be a radial fan that generates a radial outward airflow. As shown in FIG. 3A, the fan 130 inside the upper volume 108 can be surrounded by a reflective cover 302. When the fan 130 is turned on, the reflective cover 302 can redirect the radial airflow from the fan and direct it downward through the apertures 111 of the top inner wall 109, and into the cooking volume 104.

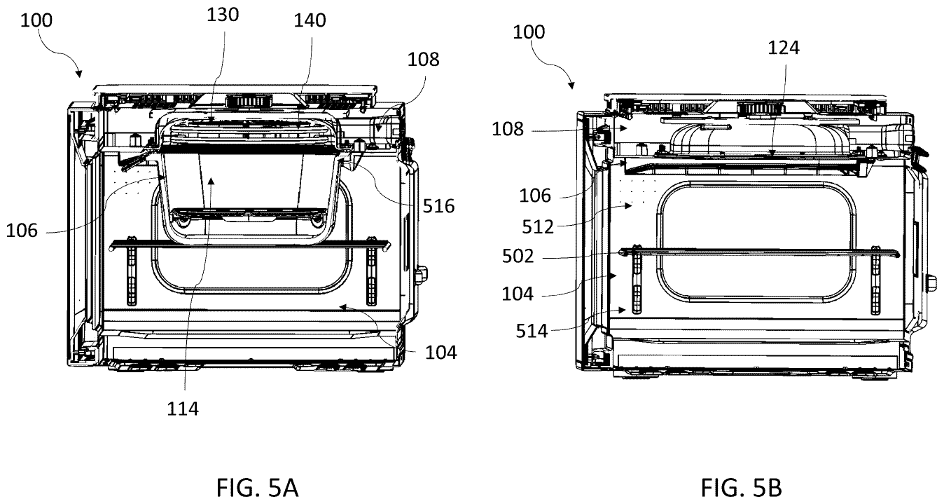

The air movement device 130 can be connected to a belt drive system 304 in order to power the air movement device 103 while allowing the height of the housing 102 to be reduced compared to traditional air fryers. As shown in FIG. 3B, a belt drive system 304 can be connected at a first point in the upper volume 108 and can be connected at a second point on the side volume 110. FIG. 4 depicts a perspective view of the belt drive system 304 configured to circulate air in the container 106. At a first point A on the upper volume 108, the belt 310 can be coupled to a first gear 402 or pulley. At a second point B on the side volume 110, the belt 310 can be connected to a second gear 404 or pulley. The first gear 402 and second gear 404 can be designed with components to allow for speed matching between a motor 405 and each respective gear 402, 404. For instance, the first gear 402 and second gear 404 can be configured with the same diameter to allow for a 1:1 gear ratio during operation of the fan. This configuration can provide for minimal power loss when operating the cooking system 100. In addition, this direct drive configuration can allow for minimal noise production from the fan 130 and, therefore the motor, which will described in greater detail below. However, different gear ratios can be used between the gears 402, 404, and should be considered within the scope of this disclosure. In an aspect, the gears 402, 404 can include gear teeth positioned on the circumferential edge of each gear. Additionally, the belt 310 can include corresponding teeth that engage with the teeth of the gears 402, 404 to help prevent slipping of the belt 310 relative to the gears 402, 404 while in operation.

The gear 402 is connected to the fan 130 via a driveshaft extending vertically down through the inner shell of the cooking volume 104. The belt 310 is configured to drive the rotation of the fan 130 and generate air circulation within the container. In an aspect, the belt 310 can be constructed of synthetic rubber to allow for an extended period of use in the cooking system 100. For instance, the cooking system can operate at high temperatures and, therefore, the belt can be constructed of urethane and polyurethane, polyvinyl chloride, or nylon fibers. In an aspect, a gear train or gears can be used in place of a belt.

In order to generate a heated airflow for a convection cooking process, the heating element 140 is positioned adjacent the fan 130 to heat the airflow generated by the fan 130. The heat source 140 can be a radiant or convective heat source that, in combination with the fan 130, can produce a stream of heated air that can travel from the upper volume 108 to the cooking volumes 104, 114. In an aspect, the heating element 140 is a cal-rod, tungsten-alloy, carbon fiber, or any other suitable heating source. In an aspect, the heating element 140 can be positioned about and radially offset from the fan 130 in the same horizontal plane. In an aspect, the heating element 130 can be cycled on and off during a cooking process depending on a desired temperature or cooking method (i.e., air fry, roast, bake).

Depending on the size of a food item and, therefore the choice to use either the container 106 and the heating element 140 or the cooking volume 104 and the microwave assembly 120, the cooking system 100 can adapt to the user's choice. For instance, when food is placed in the container 106, the cooking system 100 can activate the heating element 140 independently of the microwave assembly 120, and vis-a-versa. As will be described in greater detail below, if a user desires to heat food via the container 106, the cooking system 100 can deactivate the microwave assembly 120 to conserve energy used by the cooking system 100 during operation.

The inner container 106 can further include a cooking volume 114, where food can be positioned to receive microwaves, radiant, and/or convective heat. In an aspect, the container 106 can be metallic, glass, or a suitable polymer to let microwaves pass therethrough. The container 106 can be held on the top inner surface of the cooking volume 104 by a bracket 123 having channels 124 that extend downward from the inner top wall 109. As shown in FIG. 5C, when the container 106 is placed inside an upper cooking volume 512, the container 106 is positioned directly adjacent the fan 130 and the heating element 140. Due to this adjacent and proximal relationship, the airflow from the fan 130 and heating element 104 is substantially contained within the container 106, as shown by airflow AF. This also prevent excessive heated airflow from reaching the lower cooking volume 514. In an aspect, this can allow the heat generated by the heating element 140 to be conserved inside the cooking volume of the container 106. For instance, as the container 106 is placed inside the upper cooking volume, the channels 124 provide a support for the container through an outer lip 516 of the container 106. Looking to FIGS. 5C and 5D, the outer lip 516 can be shown to rest in the channels 124. In an aspect, the support provided by the channels 124 can act as a guide when placing the container 106 inside the upper cooking volume 512. In some embodiments, an outlet 520 can be provided between the outer lip 516 and the channels 124 when the container 106 is placed inside the upper cooking volume 512, as shown in FIG. 5D. The outlet 520 allows the cooking volume 114 to vent during a convection cooking process. For instance, as the fan 130 circulates air about the container 106, the internal temperature and pressure within will increase during operation of the cooking system 100. The outlet 520 can provide sufficient space for hot air to exit the container 106 and enter into the cooking volume 104. This aids in increasing the operational efficiency of a convection cooking process since most of the heated airflow remains within the cooking volume 114.

Due to the cooking device 100 having both a convection cooking system and a microwave cooking system, multiple cooking processes can be performed within the device. A first cooking process can include using only microwaves to heat a food product within the cooking volume 104. Additionally, a second cooking process can include producing a convection airflow to further heat and cook food within the cooking volume 104, 114. The container 106 and cooking volume 114 can be designed with an optimal volume to enhance the cooking process during operation. In an aspect, the container 106 can be configured with an internal volume within a range of 0.10 cubic feet to 0.15 cubic feet, and specifically, 0.13 cubic feet. In an aspect, the container 106 can be configured with an internal volume within a range of 0.18 cubic feet to 0.22 cubic feet, and specifically, 0.20 cubic feet. As the fan 130 circulates hot air from the heating element 140 into the container 106, the concentration of heat can increase inside the volume 114 at a faster rate compared to the cooking volume 104 due to its smaller size. In an aspect, the cooking volume 104 can be configured with an internal volume within a range of 0.70 cubic feet to 0.90 cubic feet, and specifically, 0.80 cubic feet. In an aspect, the cooking volume 104 can be configured with an internal volume within a range of 1.0 cubic feet to 1.2 cubic feet, and specifically, 1.1 cubic feet. In an aspect, a ratio of the cooking volume 104 to the volume 114 is within a range of 5.3:1 to 6.3:1. Specifically, the ratio can be 5.50:1 or 6.15:1.

Clause 1. A device, comprising: a housing having a cooking chamber formed therein, the cooking chamber comprising an inner top wall; a microwave source positioned outside of the cooking chamber, and configured to emit microwaves into the cooking chamber; an air movement device positioned within the housing, and can be vertically above the inner top wall; a heating element positioned within the housing, and can be vertically above the inner top wall; and a container selectively removable from the cooking chamber, the cooking chamber comprising a top opening for inserting a food product therein, wherein, in a first cooking mode, the container is spaced from the inner top wall, and in a second cooking mode, the container is positioned directly adjacent the inner top wall.

Clause 2. The device of clause 1, wherein the cooking chamber container comprises a bracket positioned on at least one of a sidewall or the inner top wall.

Clause 3. The device of clause 2, wherein the container comprises a projection extending outward from the container and is configured to abut the bracket in the second cooking mode.

Clause 4. The device of clause 1, wherein the inner top wall comprises at least one aperture.

Clause 5. The device of clause 1, wherein in the first cooking mode, the microwave source emits microwaves into the cooking chamber.

Clause 6. The device of clause 5, wherein in the second cooking mode, the air movement device and heating element generate a heated airflow directly into the container.

Clause 7. The device of clause 1, wherein the container partially seals to the inner top wall to reduce a rate of loss of the heated airflow from the container to the cooking chamber.

Clause 8. The device of clause 1, wherein the cooking chamber comprises a shelf positioned within the cooking chamber and spaced vertically from a bottom surface of the cooking chamber.

Clause 9. The device of clause 8, wherein the container abuts the shelf in the second cooking mode to position the container directly adjacent the inner top wall.

Clause 10. The device of clause 1, wherein the microwave source is positioned within a second chamber arranged adjacent to the cooking chamber.

Clause 11. A device, comprising: a housing forming a cooking chamber therein, the cooking chamber comprising an inner top wall; a microwave source positioned outside of the cooking chamber, and configured to emit microwaves into the cooking chamber; an air movement device positioned within the housing, and configured to generate an airflow within the cooking chamber; a heating element positioned within the housing, and configured to heat the airflow to create a heated airflow; a bracket positioned within the cooking chamber; and a container selectively removable from the cooking chamber, the cooking chamber comprising a top opening for inserting a food product therein, and a projection extending outward from the container, wherein the projection of the container contacts the bracket to position the container directly adjacent the inner top wall.

Clause 12. The device of clause 11, wherein the bracket surrounds the container on a first side, a second side, and a third side of the container.

Clause 13. The device of clause 11, wherein the bracket is positioned on at least one of the inner top wall or a sidewall of the cooking chamber.

Clause 14. The device of clause 11, wherein the inner top wall comprises a plurality of perforations to allow the heated airflow to pass through the inner top wall and into the cooking chamber.

Clause 15. The device of clause 11, wherein, in a first cooking mode, the container is spaced from the inner top wall and the microwave source emits microwaves into the cooking chamber.

Clause 16. The device of clause 15, wherein, in a second cooking mode, the container is positioned directly adjacent the inner top wall and the air movement device and heating element direct the heated airflow directly into the container.

Clause 17. The device of clause 11, wherein the bracket is spaced horizontally from a sidewall of the cooking chamber.

Clause 18. The device of clause 11, wherein the container partially seals to the inner top wall to reduce a rate of loss of the heated airflow from the container to the cooking chamber.

Clause 19. The device of clause 11, wherein the cooking chamber comprises a shelf positioned within the cooking chamber and spaced vertically from a bottom surface of the cooking chamber.

Clause 20. The device of clause 11, wherein the container abuts the shelf in the second cooking mode to position the container directly adjacent the inner top wall.

Clause 21. A device, comprising: a housing having a front surface and an opening positioned on the front surface; a door rotatably connected to the housing to selectively cover the opening; a cooking chamber formed within the housing having a first volume, wherein the cooking chamber is configured to be accessed through the opening and to cook a food product directly therein; a microwave source positioned outside of the cooking chamber, and configured to emit microwaves into the cooking chamber; an air movement device positioned within the housing; a heating element positioned within the housing; and a container having a second volume and selectively removable from the cooking chamber, the container comprising a top opening for inserting the food product therein, wherein the first volume is larger than the second volume.

Clause 22. The device of clause 21, wherein the first volume is within a range of 0.7 cubic feet to 0.9 cubic feet.

Clause 23. The device of clause 21, wherein the first volume is 0.8 cubic feet.

Clause 24. The device of clause 21, wherein the second volume is within a range of 0.10 cubic feet to 0.15 cubic feet.

Clause 25. The device of clause 21, wherein the second volume is 0.13 cubic feet.

Clause 26. The device of clause 21, wherein the first volume is within a range of 1.0 cubic feet to 1.2 cubic feet.

Clause 27. The device of clause 21, wherein the first volume is 1.1 cubic feet.

Clause 28. The device of clause 21, wherein the second volume is within a range of 0.18 cubic feet to 0.22 cubic feet.

Clause 29. The device of clause 21, wherein the second volume is 0.20 cubic feet.

Clause 30. The device of clause 21, wherein a ratio of the first volume to the second volume is within a range of 5.3:1 to 6.3:1.

Clause 31. The device of clause 21, wherein a ratio of the first volume to the second volume is 5.50:1.

Clause 32. The device of clause 21, wherein a ratio of the first volume to the second volume is 6.15:1.

Clause 33. The device of clause 21, wherein in a first cooking mode, microwave source emits microwaves into the cooking chamber.

Clause 34. The device of clause 33. wherein in a second cooking mode, the air movement device and heating element direct a heated airflow directly into the container.

Clause 35. A device, comprising: a housing forming a cooking chamber therein having a first height and a first width, the cooking chamber comprising an inner top wall; a microwave source positioned outside of the cooking chamber, and configured to emit microwaves into the cooking chamber to cook a food product directly therein; an air movement device positioned within the housing, and configured to generate an airflow within the cooking chamber; a heating element positioned within the housing, and configured to heat the airflow to create a heated airflow; and a container having a second height and a second width, and being selectively removable from the cooking chamber, the container comprising a top opening for inserting the food product therein, wherein the first height is at least double the second height.

Clause 36. The device of clause 35, wherein the cooking chamber comprises a first volume within a range of 0.7 cubic feet to 1.2 cubic feet.

Clause 37. The device of clause 36, wherein the container comprises a second volume within a range of 0.10 cubic feet to 0.22 cubic feet.

Clause 38. The device of clause 37, wherein a ratio of the first volume to the second volume is within a range of 5.3:1 to 6.3:1.

Clause 39. The device of clause 35, wherein the cooking chamber comprises a shelf positioned within the cooking chamber and spaced vertically from a bottom surface of the cooking chamber.

Clause 40. The device of clause 38, wherein the container is configured to be positioned on the shelf, and a second container is configured to be positioned below the shelf within the cooking chamber.

Clause 41. A device, comprising: a housing having a cooking chamber formed therein, the cooking chamber comprising an inner top wall and a sidewall; a microwave source positioned outside of the cooking chamber, and configured to emit microwaves into the cooking chamber; a mode stirrer positioned on the sidewall of the cooking chamber; an air movement device positioned within the housing; a heating element positioned within the housing; and a container selectively removable from the cooking chamber, the container comprising a top opening for inserting a food product therein, wherein, in a first cooking mode, the microwave source emits microwaves into the cooking chamber and the mode stirrer rotates to distribute the microwaves emitted into the cooking chamber, and in a second cooking mode, the air movement device and heating element direct a heated airflow directly into the container.

Clause 42. The device of clause 41, wherein housing comprises a second chamber arranged adjacent to the cooking chamber in a side-by-side configuration.

Clause 43. The device of clause 42, wherein the microwave source is positioned within the second chamber.

Clause 44. The device of clause 43, wherein a wave guide is positioned within the second chamber and configured to direct microwaves from the microwave source to the cooking chamber.

Clause 45. The device of clause 44, wherein the mode stirrer is positioned at an outlet of the wave guide.

Clause 46. The device of clause 45, wherein the mode stirrer is connected to a driveshaft of a motor passing through the wave guide in order to rotate the mode stirrer.

Clause 47. The device of clause 42, wherein the sidewall of the cooking chamber separates the cooking chamber from the second chamber.

Clause 48. The device of clause 41, wherein the mode stirrer comprises a first aperture and a second aperture.

Clause 49. The device of clause 48, wherein at least one of the first aperture and the second aperture is a rectangular aperture.

Clause 50. The device of clause 41, wherein the mode stirrer is asymmetric.

Clause 51. A device, comprising: a housing forming a cooking chamber therein, the cooking chamber comprising a top wall, a rear wall, and a sidewall; a microwave source positioned outside of the cooking chamber, and configured to emit microwaves into the cooking chamber; a mode stirrer positioned on the sidewall of the cooking chamber; an air movement device positioned within the housing, and configured to generate an airflow within the cooking chamber; a heating element positioned within the housing, and configured to heat the airflow to create a heated airflow; and a container selectively removable from the cooking chamber, the container comprising a top opening for inserting a food product therein.

Clause 52. The device of clause 51, wherein housing comprises a second chamber arranged adjacent to the cooking chamber in a side-by-side configuration.

Clause 53. The device of clause 52, wherein the sidewall of the cooking chamber separates the cooking chamber from the second chamber.

Clause 54. The device of clause 52, wherein the microwave source is positioned within the second chamber.

Clause 55. The device of clause 54, wherein a wave guide is positioned within the second chamber and configured to direct microwaves from the microwave source to the cooking chamber.

Clause 56. The device of clause 52, wherein a motor is positioned within the second chamber and configured to rotate the mode stirrer.

Clause 57. The device of clause 51, wherein the mode stirrer comprises a projection extending axially outward towards the cooking chamber.

Clause 58. The device of clause 57, wherein the projection is adjacent an aperture positioned within the mode stirrer.

Clause 59. The device of clause 51, wherein a mica sheet is positioned between the mode stirrer and the cooking chamber.

Clause 60. The device of clause 51, wherein the mode stirrer is asymmetric.

Clause 61. A device, comprising: a housing having a cooking chamber formed within the housing, the cooking chamber comprising an inner top wall; a microwave source positioned outside of the cooking chamber, and configured to emit microwaves into the cooking chamber; a motor positioned outside of the cooking chamber, and including a first pulley connected to a driveshaft of the motor; an air movement device positioned within the housing, the air movement device including a driveshaft extending vertically upward and having a second pulley; a belt extending between the first pulley and the second pulley, the belt configured to transfer rotational movement from the first pulley to the second pulley; a heating element positioned within the housing; and a container selectively removable from the cooking chamber, the container comprising a top opening for inserting a food product therein.

Clause 62. The device of clause 61, wherein housing comprises a second chamber arranged adjacent to the cooking chamber in a side-by-side configuration.

Clause 63. The device of clause 62, wherein the microwave source and the motor are positioned within the second chamber.

Clause 64. The device of clause 63, wherein the motor is positioned above the microwave source.

Clause 65. The device of clause 62, wherein the motor includes a cooling fan configured to rotate within the second chamber.

Clause 66. The device of clause 61, wherein the motor and the air movement device are horizontally spaced and vertically aligned from one another within the housing.

Clause 67. The device of clause 61, wherein in a first cooking mode, the motor rotates the first pulley in order to rotate the air movement device to produce an airflow.

Clause 68. The device of clause 61, wherein the second pulley is positioned vertically above the heating element.

Clause 69. The device of clause 61, wherein the first pulley includes a plurality of teeth circumferentially arranged about the first pulley.

Clause 70. The device of clause 69, wherein the belt includes a plurality of teeth corresponding to the plurality of teeth of the first pulley.

Clause 71. A device, comprising: a housing forming a cooking chamber and a second chamber therein, the cooking chamber comprising an inner top wall and a sidewall separating the cooking chamber and the second chamber; a microwave source positioned within the second chamber, and configured to emit microwaves into the cooking chamber to cook a food product directly therein; a motor positioned within the second chamber, and including a first pulley connected to a driveshaft of the motor, the first pulley positioned vertically above the cooking chamber; an air movement device positioned within the housing, and can be vertically above the inner top wall, the air movement device including a driveshaft extending vertically upward and having a second pulley vertically aligned within the first pulley; a belt extending between the first pulley and the second pulley, the belt configured to transfer rotational movement from the first pulley to the second pulley; a heating element positioned within the housing, and can be vertically above the inner top wall; and a container selectively removable from the cooking chamber, the container comprising a top opening for inserting a food product therein.

Clause 72. The device of clause 71, wherein the cooking chamber and the second chamber are arranged within the housing in a side-by-side configuration.

Clause 73. The device of clause 71, wherein the motor is positioned above the microwave source.

Clause 74. The device of clause 71, wherein the motor includes a cooling fan configured to rotate within the second chamber.

Clause 75. The device of clause 71, wherein the motor and the air movement device are horizontally spaced from one another within the housing.

Clause 76. The device of clause 71, wherein in a first cooking mode, the motor rotates the first pulley in order to rotate the air movement device to produce an airflow.

Clause 77. The device of clause 76, wherein in a second cooking mode, the microwave source emits microwaves into the cooking chamber.

Clause 78. The device of clause 71, wherein the second pulley is positioned vertically above the heating element.

Clause 79. The device of clause 71, wherein the first pulley includes a plurality of teeth circumferentially arranged about the first pulley.

Clause 80. The device of clause 79, wherein the belt includes a plurality of teeth corresponding to the plurality of teeth of the first pulley.

Certain exemplary implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used. In addition, the terms “about” and “substantially” are defined as ranges based on manufacturing variations and variations over temperature and other parameters.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1. A cooking device, comprising:
a housing having:
an opening;
a cooking chamber configured to be accessed through the opening;
a microwave source positioned outside of the cooking chamber and configured to emit microwaves into the cooking chamber; and
a heating element and an air movement device positioned above a top wall of the chamber; and
a container selectively removable from the cooking chamber, the container having a top opening for receiving a food product, wherein the container is configured to be removed from the cooking chamber in a first cooking mode, and the container is configured to be positioned such that the top opening is adjacent the top wall in a second cooking mode.

2. The cooking device of claim 1, wherein the container is configured to at least partially seal to the top wall in the second cooking mode to reduce a rate of loss of the heated airflow from the container to the cooking chamber.

3. The cooking device of claim 1, wherein the microwave source is configured to emit microwaves into the cooking chamber in the first cooking mode, and wherein the air movement device and heating element are configured to generate a heated airflow directly into the container in the second cooking mode.

4. The cooking device of claim 1, wherein the cooking chamber comprises a support on at least one of a sidewall or the top wall, and wherein a portion of the container is configured to abut the support in the second cooking mode.

5. The cooking device of claim 2, wherein the support comprises a bracket surrounding the container on a first side, a second side, and a third side of the container, and wherein the bracket is spaced horizontally from a sidewall of the cooking chamber.

6. The cooking device of claim 1, wherein the cooking chamber comprises a shelf positioned within the cooking chamber and spaced vertically from a bottom surface of the cooking chamber, and wherein the container is configured to abut the shelf in the second cooking mode to position the container directly adjacent the top wall.

7. The cooking device of claim 1, further comprising a second container configured to be positioned within the cooking chamber.

8. The cooking device of claim 1, wherein the cooking chamber has a first volume and the container has a second volume, and wherein the first volume is larger than the second volume.

9. The cooking device of claim 8, wherein a ratio of the first volume to the second volume is within a range of 5.3 to 6.3.

10. The cooking device of claim 1, wherein the cooking chamber has a first height and the container has a second height, and wherein the first height is at least double the second height.

11. The cooking device of claim 1, wherein, in the second cooking mode, the container is configured to slide into the cooking chamber along a channel in the cooking chamber such that an outer lip on the container rests within the channel.

12. The cooking device of claim 11, wherein the channel is configured to receive the outer lip such that an air outlet is formed between the channel and the outer lip, and wherein the air outlet is configured to vent air in the second cooking mode.

13. A cooking device, comprising:
a housing having an opening and a cooking chamber therein accessible through the opening;
a microwave source positioned in the housing outside of the cooking chamber and configured to emit microwaves into the cooking chamber in a first cooking mode;
a heating element and an air movement device positioned in the housing and configured to direct heated airflow into the container in a second cooking mode; and
a container selectively removable from the cooking chamber, the container being configured to at least partially seal to a wall of the chamber adjacent to the heating element and air movement device in the second cooking mode such that the air movement device and heating element are configured to direct a heated airflow directly into the container in the second cooking mode.

14. The cooking device of claim 13, wherein the cooking chamber has a first volume and the container has a second volume, and wherein the first volume is larger than the second volume.

15. The cooking device of claim 13, wherein the cooking chamber has a first height and the container has a second height, and wherein the first height is at least double the second height.

16. The cooking device of claim 13, wherein the cooking chamber comprises a support on at least one of a sidewall or the top wall, and wherein a portion of the container is configured to abut the support in the second cooking mode.

17. The cooking device of claim 13, wherein the cooking chamber comprises a top wall, a rear wall, and a sidewall, wherein the air movement device and the heating element are both positioned above the top wall.

18. A cooking device, comprising:
a housing having a first cooking chamber and an opening for accessing the first cooking chamber, the first cooking chamber defining a first volume;
a microwave source positioned in the housing outside of the first cooking chamber;
a heating element and an air movement device positioned in the housing; and
a container configured to be removably disposed within the first cooking chamber, the container defining a second cooking chamber with a second volume that is less than the first volume;
wherein the microwave source is operable in a first cooking mode in which the container is removed from the first cooking chamber and the microwave source is configured to emit microwaves into the first cooking chamber to heat food within the first cooking chamber; and
wherein the heating element and air movement device are operable in a second cooking mode in which the container is disposed within the first cooking chamber and the heating element and air movement device are configured to direct heated airflow directly into the second cooking chamber to heat food within the second cooking chamber.

19. The cooking device of claim 18, wherein the container is configured to seal to a sidewall the cooking chamber adjacent to the heating element and air movement device when the container is disposed within the cooking chamber.

20. The cooking device of claim 18, wherein the first cooking chamber has a first height and the second cooking volume has a second height, and wherein the first height is at least double the second height.

21. The cooking device of claim 18, wherein the microwave source is positioned adjacent to a sidewall of the first cooking chamber, and the heating element and air movement device are positioned adjacent to a top wall of the first cooking chamber.

22. The cooking device of claim 18, wherein a ratio of the first volume to the second volume is within a range of 5.3 to 6.3.

23. The cooking device of claim 18, wherein the cooking chamber comprises a rail on at least one of a sidewall or the top wall and configured to support the container within the first cooking chamber.
